(19) United States
(12) Patent Application Publication
(10) Pub. No.: US 2026/0001048 A1
(43) Pub. Date: Jan. 1, 2026

(54) LIQUID SUSPENSIONS FOR USE AS DRYING AGENTS

(71) Applicants: Timothy Deshon Hutton, The Woodlands, TX (US); Jonathan David Heinen, Pella, IA (US)

(72) Inventors: Timothy Deshon Hutton, The Woodlands, TX (US); Jonathan David Heinen, Pella, IA (US)

(21) Appl. No.: 19/205,184

(22) Filed: May 12, 2025

Related U.S. Application Data
(60) Provisional application No. 63/645,267, filed on May 10, 2024.

(51) Int. Cl. B01F 23/50; B01F 23/70; B01F 27/05; B01F 101/00; B01F 101/24; B01F 101/40; B08B 3/14; B08B 7/04

(52) U.S. Cl. CPC B01F 23/511; B01F 23/56; B01F 23/711; B01F 27/05; B08B 3/14; B08B 7/04; B01F 2101/24; B01F 2101/2805; B01F 2101/40; B08B 2203/00

(57) ABSTRACT

Liquid suspensions are disclosed that include superabsorbent polymer suspended within a non-aqueous liquid. The liquid suspensions are capable of being pumped and sprayed onto waste fluids for clean-up procedures. The liquid suspensions can be made by high shear mixing of the superabsorbent polymer with the non-aqueous liquid until the superabsorbent polymer is suspended within the non-aqueous liquid.

### CROSS-REFERENCE TO RELATED APPLICATIONS

The present application claims the benefit of U.S. Provisional Patent Application No. 63/645,267 (pending), filed on May 10, 2024, and entitled “Liquid Suspensions For Use as Drying Agents”, the entirety of which is incorporated herein by reference and made a part of the present disclosures.

### FIELD

The present disclosure relates to liquid suspensions for use as drying agents and to methods of making and using the same.

### BACKGROUND

Drying agents are typically in dry, solid form, such as in the form of a powder, pellet, or other solid state composition. Some drying agents are, or include, superabsorbent polymer (SAP). SAP is considered environmentally safe and is used in a variety of applications where the SAP comes into contact with skin and/or food, including consumer products such as diapers and absorbent sheets for use in meat packaging. SAP operates by absorbing aqueous liquids from the surrounding environment. SAP may slowly release some of the absorbed material in gaseous form. Some SAP particles can absorb a weight of liquid that is approximately three-hundred times the weight of the particle. However, SAP has a tendency to clump and agglomerate upon application to a waste fluid and/or upon absorption of waste fluids, which negatively affects the absorption and retrieval processes. Additionally, SAP can be challenging to apply in certain applications.

### BRIEF SUMMARY

Embodiments of the present disclosure include a liquid suspension for use in cleaning waste fluids. The liquid suspension includes a non-polar liquid and a plurality of particles of superabsorbent polymer. The plurality of particles are suspended within the non-polar liquid.

Embodiments of the present disclosure include a method of making a liquid suspension. The method includes providing a plurality of particles of superabsorbent polymer. The method includes providing a non-polar liquid. The method includes mixing the plurality of particles of superabsorbent polymer with the non-polar liquid until at least a portion of the plurality of particles of superabsorbent polymer are suspended within the non-polar liquid; thereby, forming the liquid suspension.

Embodiments of the present disclosure include a method of cleaning up a waste fluid at a site. The method includes providing a liquid suspension at the site where the waste fluid is present. The liquid suspension includes a plurality of particles of superabsorbent polymer suspended within a non-polar liquid. The method includes applying the liquid suspension onto the waste fluid at the site. Upon or after the application of the liquid suspension onto the waste fluid, the plurality of particles of superabsorbent polymer absorb at least a portion of the waste fluid. The method includes retrieving the plurality of particles of superabsorbent polymer, with the waste fluid absorbed therein, from the site.

Embodiments of the present disclosure include a system for making a liquid suspension for cleaning waste fluids. The system includes a mixer having a mixing chamber. The system includes a source of a non-polar liquid in fluid communication with the mixing chamber. The system includes a source of a plurality of particles comprising superabsorbent polymer in fluid communication with the mixing chamber. An agitator is positioned in the mixing chamber and configured to mix the plurality of particles with the non-polar liquid until the particles are suspended within the non-polar liquid.

### BRIEF DESCRIPTION OF THE DRAWINGS

So that the manner in which the features and advantages of the compositions and methods of the present disclosure may be understood in more detail, a more particular description briefly summarized above may be had by reference to the embodiments thereof which are illustrated in the appended drawings that form a part of this specification. It is to be noted, however, that the drawings illustrate only various exemplary embodiments and are therefore not to be considered limiting of the disclosed concepts as it may include other effective embodiments as well.

FIG. 1 is a simplified schematic illustrating a liquid suspension in accordance with embodiments of the present disclosure.

FIG. 2 is a simplified flow chart of a method of making the liquid suspension in accordance with embodiments of the present disclosure.

FIGS. 3A-3D illustrate use of the liquid suspension to clean up a waste fluid in accordance with embodiments of the present disclosure.

FIG. 4 depicts a system suitable for use in making the liquid suspension in accordance with embodiments of the present disclosure.

### DETAILED DESCRIPTION

Embodiments of the present disclosure include liquid suspensions suitable for use as drying agents, such as for use in clean-up and drying applications as well as other applications. While described herein as being used as a “drying agent,” the liquid suspension compositions disclosed herein are not limited to any particular use.

### Liquid Suspension

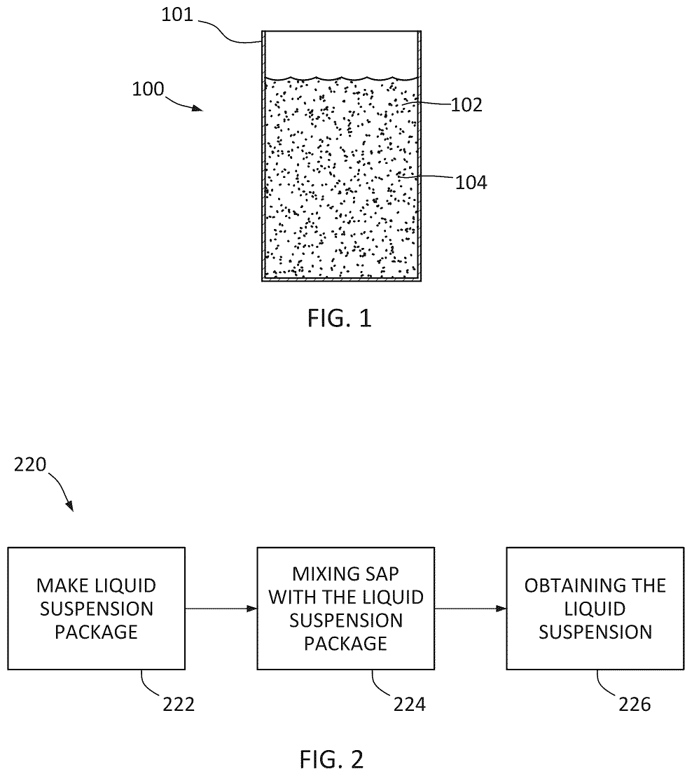

The compositions disclosed herein are in the form of a liquid suspension. With reference to FIG. 1, a simplified schematic of a container 101 with composition, liquid suspension 100, therein is depicted. Liquid suspension 100 includes at least one liquid component 102 mixed with at least one solid component 104. The liquid component 102 is capable of functioning as a suspension medium for the solid component 104, such that the liquid suspension 100 is a heterogeneous mixture in which the solid component 104 forms a dispersed phase of the liquid suspension 100 and the liquid component 102 forms a continuous phase of the liquid suspension 100. At least a portion of the solid component 104 is suspended within the liquid component 102. In some embodiments, at least a portion of the solid component 104 is in solution within the liquid component 102. The liquid suspension 100 may include from 25 weight percent to 75% weight percent, or from 35 weight percent to 65% weight percent, or from 45 weight percent to 55% weight percent of the liquid component 102 based on a total weight of the liquid suspension 100, or any discrete value or range therebetween. The liquid suspension 100 may include from 25 weight percent to 75% weight percent, or from 35 weight percent to 65% weight percent, or from 45 weight percent to 55% weight percent of the solid component 104, based on the total weight of the liquid suspension 100, or any discrete value or range therebetween.

### Liquid Component

The liquid component 102 can be or include one or more non-polar liquids and/or non-aqueous liquids. In some embodiments, the liquid component 102 includes liquid hydrocarbons, such as oils, hydrocarbon solvents, and/or petroleum distillates. The liquid component 102 can be or include a solvent or diluent, such as an aliphatic solvent or isoparaffin solvent. The liquid component 102 can be or include an oil, such as a mineral oil, a paraffinic oil (e.g., a thickened paraffinic oil), a process oil, and/or a naphthenic oil. The oil can be a conventional, natural oil or a synthetic oil. The liquid component 102 can be a single component (e.g., a single oil or solvent), or can be a mixture of multiple different liquids. Table 1, below lists some exemplary commercially available liquids that are suitable for use as at least a portion of the liquid component 102 disclosed herein. The liquid component 102 is not limited to containing any of these commercially available liquids, which are provided only as examples. In some embodiments, the liquid suspension 102 has a kinematic viscosity of about 60,000 cST at 25° C.

TABLE 1
Exemplary Liquid Components

| Type of Liquid | Tradename of Commercially | |
|---|---|---|
| Component | Available Example | Source |
| Aliphatic Solvent | CONOSOL C-200 | Barsol Solvents, Inc. |
| Thickened | FORMULA F | Chevron Philips |
| Paraffinic Oil | CONCENTRATE | Chemical |
| Process Oil | PARALUX | Chevron Lubricants |
| Diluent | ORFOM SX-12 | Chevron Philips |
| | | Chemical |
| Diluent | ORFOM SX-80 | Chevron Philips |
| | | Chemical |
| Synthetic Oil | SYNFLUID | Chevron Philips |
| | | Chemical |
| Isoparaffinic | SOLTROL 170 | Chevron Philips |
| Solvent | | Chemical |
| Isoparaffinic | SOLTROL 220 | Chevron Philips |
| Solvent | | Chemical |

The liquid component 102 has a viscosity that is sufficient to suspend the solid component 104. In some embodiments, the liquid component 102 has a kinematic viscosity of at least 60,000 cST at 25° C. The physical and/or chemical properties of the solid component 104 and the liquid component 102 are such that the solid component 104 does not absorb the liquid component 102, or at least does not substantially absorb the liquid component 102. For example, the solid component 104 has physical and/or chemical properties such that the solid component 104 absorbs polar liquids, such as aqueous liquids, and the liquid component 102 is non-polar, preventing or resisting absorption of the liquid component 102 by the solid component 104. The liquid component 102 disclosed herein is liquid at standard, ambient conditions (e.g., at IUPAC Standard Conditions, also known as Standard Temperature and Pressure (STP) or Standard State Conditions). The liquid component 102 disclosed herein may be liquid at a temperature of 0° C. (273.15 K) and a pressure of 100 kPa (1 bar).

### Solid Component

The solid component 104 is a solid absorbent material that is capable of absorbing polar liquids, such as aqueous liquids. In some embodiments, the solid absorbent material is a polymer, such as SAP. The SAP may be or include sodium polyacrylate polymer. In some embodiments, the sodium polyacrylate is crosslinked. The SAP can be in the form of particles, flakes, and/or powder. While SAP has the property of absorbing water and other aqueous and polar mediums, SAP does not absorb, or does not substantially absorb, non-aqueous and/or non-polar liquid mediums such as the liquid component 102. As such, the SAP can be maintained in suspension within the liquid component 102 without absorbing, or without substantially absorbing, the liquid component 102 and while maintaining the capability of absorbing aqueous liquid mediums for clean-up procedures.

### Method of Making

Embodiments of the present disclosure include methods of making liquid suspension compositions suitable for use as drying agents. With reference to FIG. 2, a flow chart of an exemplary method of making the liquid suspension is depicted. Method 220 includes making a liquid suspension package, step 222. Making the liquid suspension package can include providing a liquid component. The liquid component can be a liquid hydrocarbon, such as mineral oil or aliphatic solvent. In some embodiments, making the liquid suspension package includes mixing one or more liquid hydrocarbons together to form the liquid component, such as mixing mineral oil with aliphatic solvent.

Method 220 includes mixing a solid component, such as SAP in powder form, with the liquid suspension package, step 224. In some embodiments, the SAP is mixed with the liquid suspension package using an inline high-shear mixer. The mixer can constantly circulate the liquid and solid components at a high rate of flow to form the liquid suspension. The SAP and liquid suspension package are mixed sufficiently such that the SAP becomes suspended within the liquid suspension package, forming the liquid suspension. In some embodiments, the liquid component, solid component, or both are mixed at a temperature of from 70° F. to 110° F., or from 80° F. to 100° F., or from 85° F. to 95° F., or any range or discrete value three-between.

The method 220 includes obtaining the liquid suspension, step 226.

While described as a suspension, one skilled in the art would understand that, depending on the constituents of the liquid and solid components, in some embodiments at least a portion of the solid component may be in solution within the liquid component, and in some embodiments at least a portion of the solid component may be settled or precipitated out of the liquid component.

### Methods of Use

The liquid suspensions disclosed herein are suitable for use in myriad of applications, including as drying agents for drying aqueous spills. Some exemplary applications include drilling fluid cleanup, environmental remediation, and medical waste cleanup. Some exemplary waste fluids that the liquid suspensions can be used to dry and clean-up include, but are not limited to, drilling waste fluids, such as drill cuttings and drilling mud; industrial waste fluids, such as wastewater sludge, contaminated sediments, waste treatment pits, coal ash, dredged spoils, water treatment sludge, and mine tailings; and medical and laboratory wastes, such as suction canister fluid, wound exudate, pharmaceutical disposal, and food testing fluids.

The provision of SAP in the form of a liquid suspension provides several benefits relative to a dry form of SAP for absorbing waste fluids to clean a site. For example, SAP in the form of a liquid suspension is more readily pumped and/or sprayed onto a waste fluid, providing a more effective delivery mechanism relative to a dry and solid form of SAP. Also, SAP in the form of a liquid suspension is capable of being mixed more effectively with a waste fluid, and is less subject to clumping and agglomeration upon application to a waste fluid, as the particles of the SAP are separate from one another within the liquid suspension. Additionally, SAP in the form of a liquid suspension has a relatively long shelf-life in comparison to dry SAP, as dry SAP has a greater tendency to absorb liquid from the surrounding environment (e.g. from the surrounding air), while the liquid of the liquid suspension acts as a barrier between the surrounding environment and the SAP within the liquid suspension.

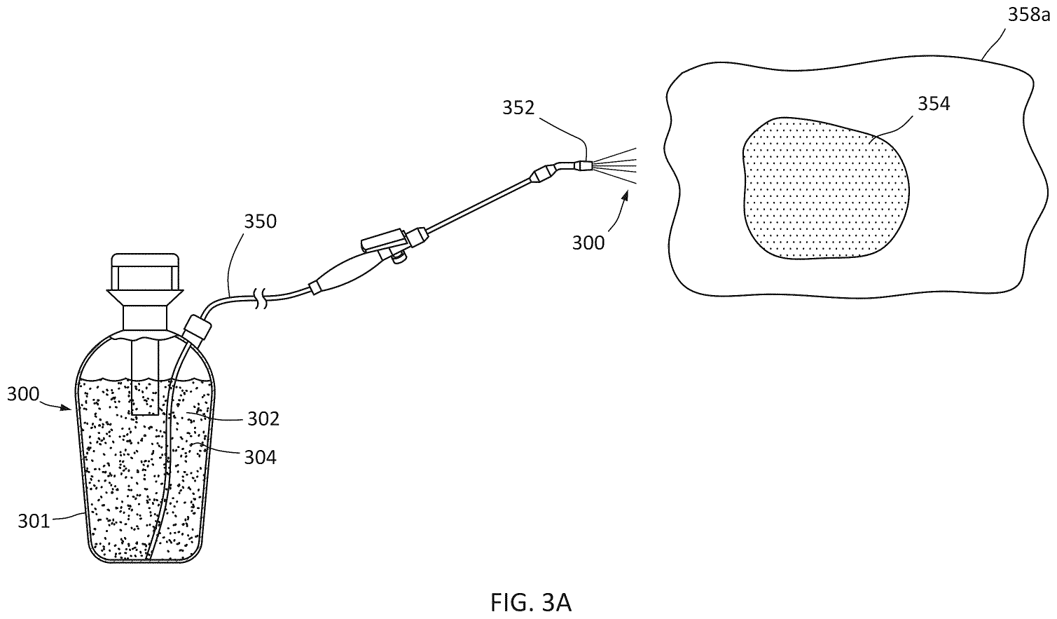

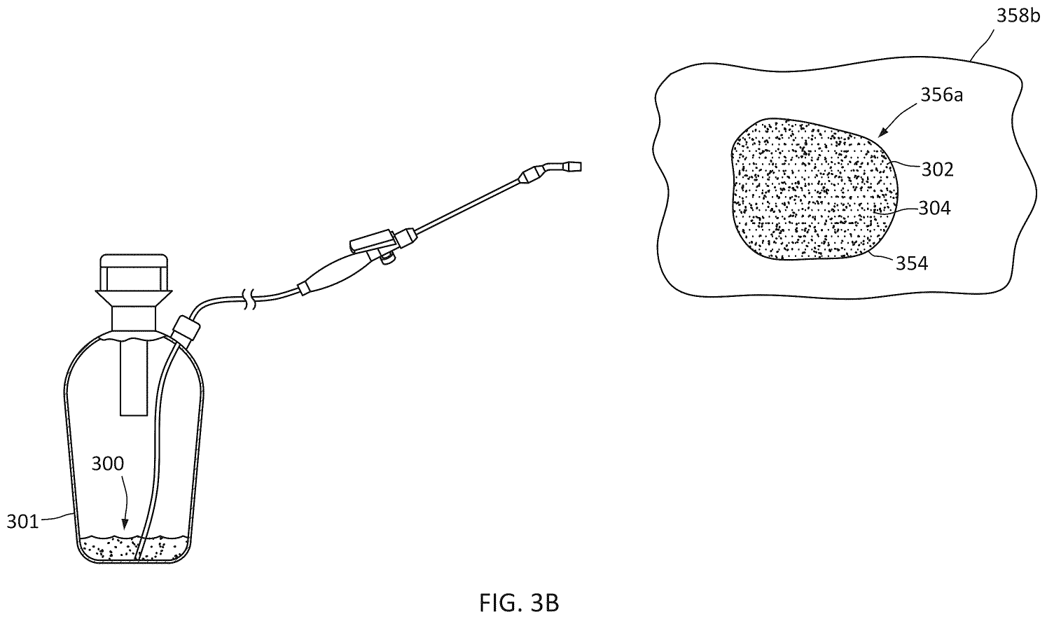

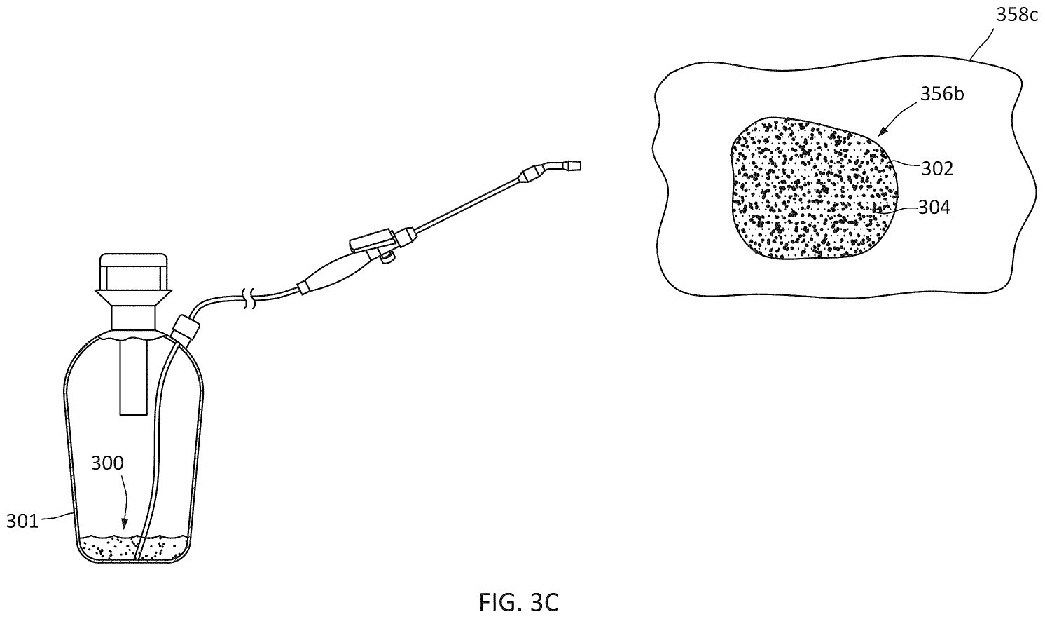

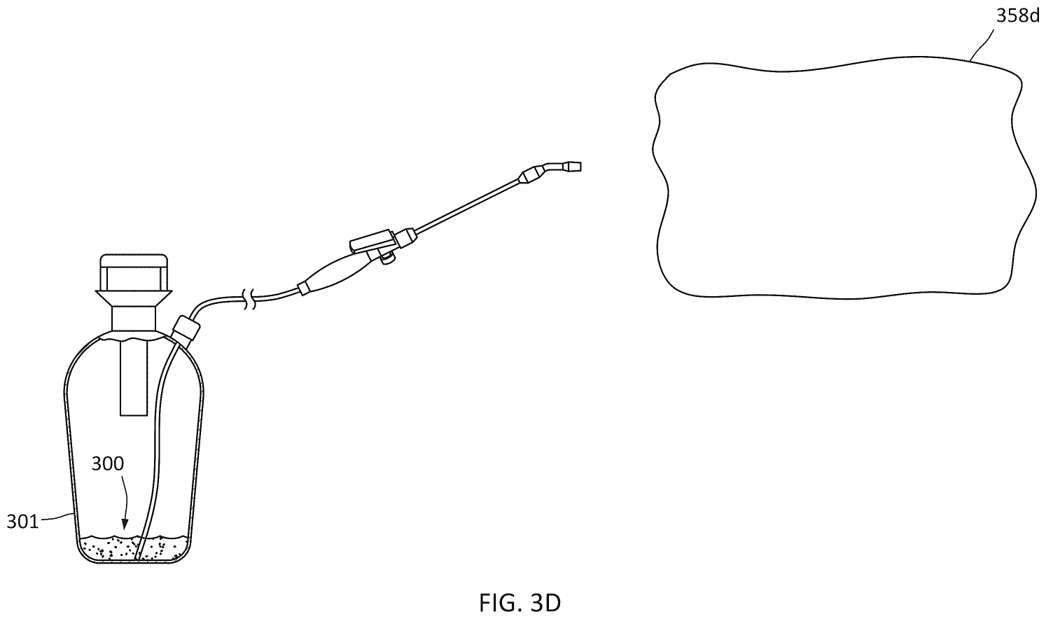

Methods of using the liquid suspensions for the clean-up of waste fluids can, generally, include: (1) applying (e.g., spraying) the liquid suspension onto a waste fluid present at a site; (2) after applying the liquid suspension, leaving the liquid suspension at the site to mix with and absorb the waste fluid for a residence time; and (3) after the residence time, retrieving the liquid suspension with the waste fluid absorbed therein. FIGS. 3A-3D are simplified schematics illustrating a clean-up of a waste fluid using the liquid suspension disclosed herein.

With reference to FIG. 3A, a contaminated site 358a is shown. The contaminated site 358a may be, for example, a drilling rig site; a site of an environmental spill; a medical facility; an industrial felicity, such as a petrochemical refinery or chemical processing plant; a waste treatment facility; an industrial mine site; or a laboratory. A waste fluid 354 is at the contaminated site 358a. The waste fluid 354 may be, for example, a drilling waste fluid, such as drill cuttings and drilling mud; an industrial waste fluid, such as wastewater sludge, contaminated sediments, waste treatment pits, coal ash, dredged spoils, water treatment sludge, and mine tailings; or medical and laboratory waste, such as suction canister fluid, wound exudate, pharmaceutical disposal, and food testing fluids. The liquid suspension 300 can be transported to the contaminated site 358a, if not already present. For example, the liquid suspension 300 can be transported within container 301 to the contaminated site 358a. The liquid suspension 300 includes a solid component 304 suspended within a liquid component 302. At the contaminated site 358a, the liquid suspension 300 an be applied onto the waste fluid 354. For example, and without limitation, the liquid suspension 300 can be sprayed and/or pumped onto the waste fluid 354. In some embodiments, the container 301 is a sprayer including a hose 350 and nozzle 352. For example, the container 301 can be a hand-operated pump sprayer or a commercial-grade sprayer. In some embodiments, the liquid suspension can be applied by adding it into a vacuum excavator tank while on a jobsite. The liquid suspension 300 can be sprayed from the nozzle 352 of the container 301 onto the waste fluid 354. In some embodiments, spraying the liquid suspension 100 forms an aerosol of the liquid suspension 102. In some applications, the liquid suspension can be injected onto or into a site for drying up of a waste fluid. Application of the liquid suspension is not limited to spraying, pumping, or injecting, and may include other application techniques used to deposit liquids. In some embodiments, the liquid suspension has a flash point that is greater than 98° C.

With reference to FIG. 3B, after applying the liquid suspension 300 onto the waste fluid 354, the liquid suspension mixes with the waste fluid 354 to form a combined mixture 356a at the contaminated site 358b. The combined mixture 356a contains the waste fluid 354, the liquid component 302, and the solid component 304. The combined mixture 356a is left for a residence time, such as from 1 to 24 hours or any discrete value or range therebetween. The residence time should be sufficient to allow the solid component 304 (e.g., SAP) to absorb at least a portion of the waste fluid 354. In some embodiments, the combined mixture 356a is subjected to mixing and/or agitation prior to, during, and/or after the residence time to facilitate absorption of the waste fluid 354 by the solid component 304. In some embodiments, the volume ratio of liquid suspension 300 to waste fluid 354 is approximately 1 gallon of liquid suspension 300 for every 100 gallons of waste fluid 354.

With reference to FIG. 3C, after the residence time, the solid component 304 has absorbed the waste fluid 354. The combined mixture 356b at the contaminated site 358c still contains the waste fluid 354, the liquid component 302, and the solid component 304. However, the waste fluid 354 is not shown as it is absorbed within the solid component 304. The solid component 304 may swell upon absorption of the waste fluid 354. With the waste fluid 354 absorbed into the solid component 304, the waste fluid 354 can be removed in solid form (i.e., absorbed within the solid component 304), facilitating easier clean-up of the waste fluid 354.

With reference to FIG. 3D, after the residence time, the combined mixture 356b is removed such that the site 358d is clean and no longer contaminated via waste fluid 354. Depending on the contents of the waste fluid, the combined mixture 356b, after absorption of the waste fluid 354, can be transported and disposed of in an appropriate facility, such as a solid waste facility. In some embodiments, the combined mixture 356b is capable of passing a paint filter test for solid waste disposal. In some embodiments, the liquid component 302 evaporates prior to or after removal of the combined mixture 356b.

### System

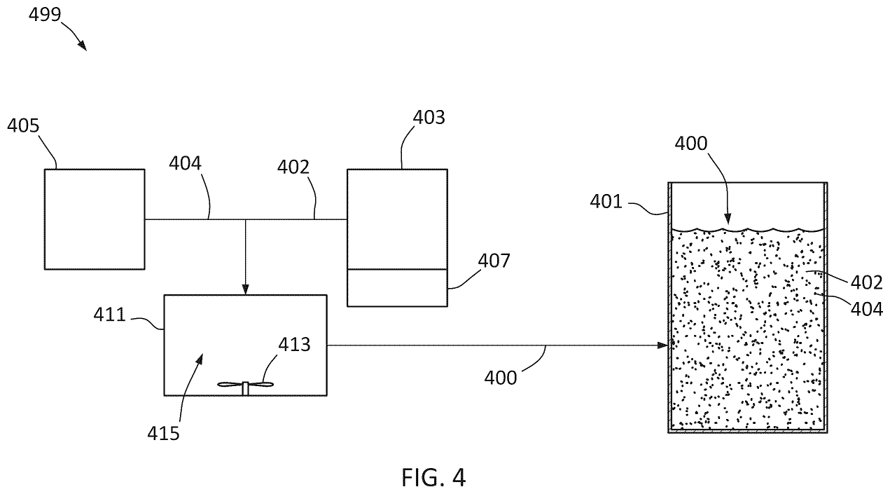

FIG. 4 depicts a system suitable for use in making the liquid suspension. System 499 includes a source of superabsorbent polymer 405, a source of non-polar liquid 403, and a mixer 411 (e.g., an inline mixer). The source of superabsorbent polymer 405 provides the solid component 404 into a mixing chamber 415 of the mixer 411. The source of non-polar liquid 403 provides the liquid component 402 into the mixing chamber 415. The non-polar liquid 402 can be heated via heater 407. Within the mixing chamber 415 the solid component 404 and liquid component 402 are mixed together via agitator 413, forming the liquid suspension 400. After mixing, the liquid suspension 400 is dispensed from the mixer to a container 401.

### EXAMPLE

The following is an example of production of one exemplary batch of a liquid suspension in accordance with the present disclosure. The liquid suspensions disclosed herein are not limited to this particular embodiment, which is presented for exemplary purposes only.

One-thousand pounds of a first liquid component carrying agent, FORMULA F CONCENTRATE, was warmed, under an insulated blanket, to a temperature of 80° F. After warming, 273 pounds of a second liquid component, CONOSOL C-200, was blended with the warmed FORMULA F CONCENTRATE. Blending of the first and second liquid components was performed for several minutes with a high-sheer mixer. After the initial blending of the FORMULA F CONCENTRATE and CONOSOL C-200, a solid component, SAP in powder form, was added to the blend of the liquid components. With the SAP introduced, the batch was blended with the high-sheer mixer for an additional 20 minutes to form the batch of the liquid suspension containing FORMULA F CONCENTRATE, CONOSOL C-200, and SAP.

Although the present embodiments and advantages have been described in detail, it should be understood that various changes, substitutions and alterations can be made herein without departing from the spirit and scope of the disclosure. Moreover, the scope of the present application is not intended to be limited to the particular embodiments of the composition or methods and steps described in the specification. One of ordinary skill in the art will readily appreciate from the disclosure presently embodiments that existing or later to be developed embodiments that perform substantially the same function or achieve substantially the same result as the corresponding embodiments described herein may be utilized according to the present disclosure. Accordingly, the appended claims are intended to include within their scope such processes, compositions, methods, or steps.

1. A liquid suspension for use in cleaning waste fluids, the liquid suspension comprising:
a non-polar liquid; and
a plurality of particles comprising superabsorbent polymer, wherein the plurality of particles are suspended within the non-polar liquid.

2. The liquid suspension of claim 1, wherein the non-polar liquid comprises a hydrocarbon.

3. The liquid suspension of claim 2, wherein the hydrocarbon comprises a solvent.

4. The liquid suspension of claim 3, wherein the solvent is an aliphatic solvent.

5. The liquid suspension of claim 3, wherein the solvent is an isoparaffin solvent.

6. The liquid suspension of claim 2, wherein the hydrocarbon comprises an oil.

7. The liquid suspension of claim 6, wherein the oil comprises mineral oil.

8. The liquid suspension of claim 6, wherein the oil comprises paraffinic oil.

9. The liquid suspension of claim 6, wherein the oil comprises thickened paraffinic oil.

10. The liquid suspension of claim 6, wherein the oil comprises a conventional, natural oil or a synthetic oil.

11. (canceled)

12. The liquid suspension of claim 6, wherein the oil comprises process oil.

13. The liquid suspension of claim 6, wherein the oil comprises naphthenic oil.

14. The liquid suspension of claim 2, wherein the hydrocarbon comprises a petroleum distillate.

15. The liquid suspension of claim 2, wherein the hydrocarbon comprises a mixture of oil and solvent.

16. The liquid suspension of claim 2, wherein the hydrocarbon comprises a mixture of at least two of: an aliphatic solvent, an isoparaffin solvent, a mineral oil, a paraffinic oil, a process oil, a naphthenic oil, and a petroleum distillate.

17. The liquid suspension of claim 1, wherein the non-polar liquid has a viscosity that is sufficient to maintain the plurality of particles suspend therein.

18. The liquid suspension of claim 1, wherein the liquid suspension comprises from 35 wt. % to 55 wt. % of the non-polar liquid and from 45 wt. % to 55 wt. % of the plurality of particles of superabsorbent polymer, each based on a total weight of the liquid suspension.

19. A method of making a liquid suspension, the method comprising:
providing a plurality of particles of superabsorbent polymer;
providing a non-polar liquid; and
mixing the plurality of particles of superabsorbent polymer with the non-polar liquid until at least a portion of the plurality of particles of superabsorbent polymer are suspended within the non-polar liquid, forming the liquid suspension.

20. (canceled)

21. The method of claim 19, wherein the mixing is performed using an inline high-shear mixer.

22. The method of claim 19, wherein the mixing is performed by circulating the non-polar liquid and the plurality of particles of superabsorbent polymer in a mixing chamber.

23. The method of claim 19, comprising, prior to mixing, heating the non-polar liquid.

24-34. (canceled)

35. A method of cleaning up a waste fluid at a site, the method comprising:
providing a liquid suspension at the site, wherein the waste fluid is present at the site, and wherein the liquid suspension comprises a plurality of particles of superabsorbent polymer suspended within a non-polar liquid;
applying the liquid suspension onto the waste fluid at the site;
wherein, upon or after the application of the liquid suspension onto the waste fluid, the plurality of particles of superabsorbent polymer absorb at least a portion of the waste fluid; and
retrieving the plurality of particles of superabsorbent polymer, with the waste fluid absorbed therein, from the site.

36. The method of claim 35, wherein the waste fluid comprises:
drill cuttings, drilling mud, or combinations thereof; or
wastewater sludge, contaminated sediment, coal ash, dredged spoils, water treatment sludge, or mine tailings; or
exudate, suction canister fluid, pharmaceutical disposal fluid, or food testing fluid.

37. (canceled)

38. (canceled)

39. The method of claim 35, wherein the site is a drilling rig site; a site of an environmental spill; a medical facility; a petrochemical refinery or chemical processing plant; a waste treatment facility; a mine site; or a laboratory.

40. The method of claim 35, wherein the applying comprises pumping the liquid suspension onto the waste fluid, spraying the liquid suspension onto the waste fluid, or injecting the liquid suspension into the site and onto the waste fluid.

41. (canceled)

42. (canceled)

43. The method of claim 35, comprising, after applying the liquid suspension, mixing and/or agitating the liquid suspension and the waste fluid to facilitate absorption of the waste fluid by the plurality of particles of superabsorbent polymer.

44. The method of claim 35, comprising, after applying the liquid suspension and before retrieving the plurality of particles of superabsorbent polymer with the waste fluid absorbed therein, allowing the plurality of particles of superabsorbent polymer to remain on the waste fluid for a residence time.

45. (canceled)

46. The method of claim 35, comprising, after retrieving the plurality of particles of superabsorbent polymer with the waste fluid absorbed therein, transporting the plurality of particles of superabsorbent polymer with the waste fluid absorbed therein to a disposal site; and
disposing of the plurality of particles of superabsorbent polymer with the waste fluid absorbed therein at the disposal site.

47-60. (canceled)
